(19) United States
(12) Patent Application Publication
(10) Pub. No.: US 2006/0230439 A1
(43) Pub. Date: Oct. 12, 2006

(54) Trusted platform module apparatus, systems, and methods

(76) Inventors: Ned M. Smith, Beaverton, OR (US); David W. Grawrock, Aloha, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/094,840

(22) Filed: Mar. 30, 2005

(51) Int. Cl. H04L 9/32

(52) U.S. Cl. 726/9

(57) ABSTRACT

Apparatus and systems, as well as methods and articles, may operate to distribute a cryptographic key across a physically protected communication channel coupling a first trusted platform module (TPM) to a second TPM.

### TECHNICAL FIELD

Various embodiments described herein relate to trusted computing technology generally, including apparatus, systems, and methods used in cryptographic key-exchange between trusted platform modules.

### BACKGROUND INFORMATION

Establishing secure computing environments may include creating trust relationships between computing platforms to enhance authentication, integrity, confidentiality, and control associated with transactions between the platforms. Secure computing platforms may thus initiate transactions by exchanging encryption keys, including public portions of asymmetric key-exchange keys (KEKs). In some cases, a platform may utilize a shielded controller, sometimes called a “trusted platform module” (TPM), to uniquely identify the platform globally, to construct and exchange encryption keys, and to perform other tasks associated with establishing and enforcing the secure computing environment. However, the use of globally unique identifiers (e.g., endorsement keys, attestation keys) may raise privacy concerns. Without the use of globally unique identifiers, on the other hand, a first TPM coupled to a computing platform may be unable to determine whether communications received from a second TPM are associated with the same platform.

### BRIEF DESCRIPTION OF THE DRAWINGS

FIG. 1 is a block diagram of apparatus and systems according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

Various embodiments disclosed herein may operate to establish a secure communication channel between partitions associated with a multi-partitioned computing platform. A multi-ported, multi-owner TPM (“multi-TPM”) may provide implicit authentication between partitions without using globally-unique identifiers by confidentially generating and distributing encryption keys between the partitions. This approach may provide a high level of authentication security for communications between buses, channels, and other interconnection components within a computing platform.

In the interest of clarity, various embodiments may describe a “first TPM” and a “second TPM” associated with a “first partition” and a “second partition,” respectively. This usage is to be understood as merely one possible example among many, and not as a limitation. Thus, various embodiments may include a plurality N=2 or more of TPM devices (collectively referred to as a multi-TPM) and associated secure computing partitions.

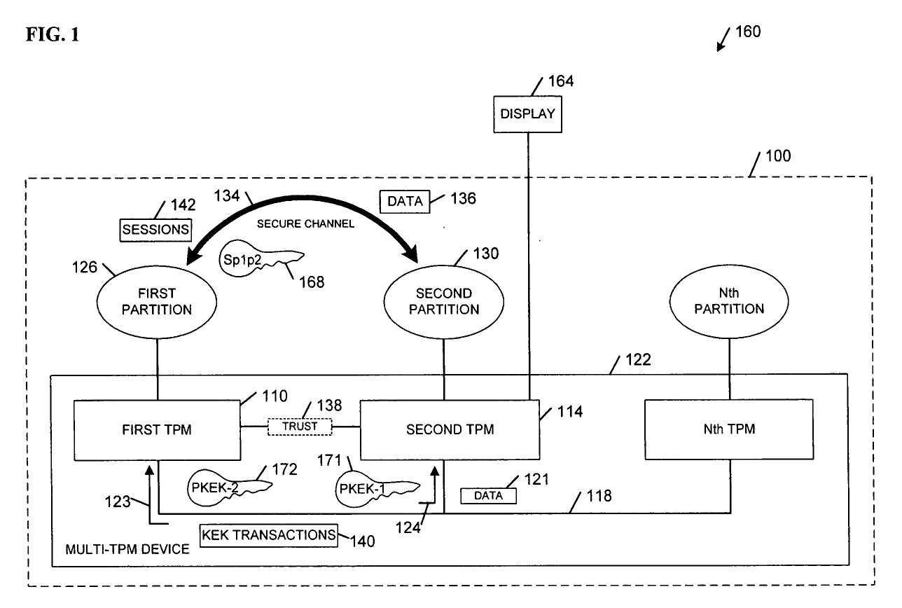

FIG. 1 comprises a block diagram of apparatus 100 and systems 160 according to various embodiments of the invention. An apparatus 100 may include a first TPM 110 and a second TPM 114 to couple to the first TPM 110 by a protected communication channel 118. In some embodiments, the first TPM 110, the second TPM 114, and perhaps the protected communication channel 118 may be included within a single integrated circuit package 122.

Data 121 traversing the protected communication channel 118 may include encryption key distributions 123, 124, for example, and may be inaccessible except by the first TPM 110 or the second TPM 114. The data 121 may be protected by physically isolating the protected communication channel 118 from data probing operations. The channel 118 may comprise a destructible-on-probing material, or a combination of materials such as a thin, soft conductor on a hard substrate, for example. This construction may thwart an attempt to capture data from the protected channel 118 by exposing the soft conductors to electrical contact by a data collection probe. Such attempts may damage the structure of the channel 118 and thereby render it inoperable before data could be captured.

The apparatus 100 may also include a first computing platform partition 126 coupled to the first TPM 110 and a second computing platform partition 130 coupled to the second TPM 114. The first computing platform partition 126 and the second computing platform partition 130 may each comprise hardware and/or software including microprocessors, controllers (e.g., wireless local area network controllers), memories, mass storage devices (e.g., hard disk drives, optical disk drives), input-output devices (e.g., keyboards, mice), power supplies, clocks, transceivers, operating systems, software applications, as well as combinations of these elements. The first computing platform partition 126, the second computing platform partition 130, and any hardware and/or software included in these partitions may comprise real partitions, virtual machine partitions, or combinations of real and virtual partitions.

The apparatus 100 may further include a secure communication channel 134 to couple the first computing platform partition 126 to the second computing platform partition 130. The secure communication channel 134 may comprise a bus, a channel, an interface, a wireless link, shared access to a memory, or shared access to a data storage device such as a magnetic disk drive or an optical disk drive, for example.

The first computing platform partition 126 may authenticate the second computing platform partition 130 for the purpose of securely communicating data 136 between partitions 126, 130 over the secure communication channel 134. The authentication may include establishing a trust relationship 138 using key exchange key (KEK) protocol transactions 140 between the first TPM 110 and the second TPM 114. Some embodiments of the apparatus 100 (e.g., embodiments wherein the first TPM 110 and the second TPM 114 are coupled together using the protected channel 118) may operate to abbreviate secure data communication sessions 142 by performing the KEK transactions 140 at a time prior to initiation of one or more of the secure data communication sessions 142.

Other embodiments may be realized. A system 160 may include one or more of the apparatus 100, including a first TPM 110, a second TPM 114 to couple to the first TPM 110 by a protected communication channel 118, wherein data 121 traversing the protected communication channel 118 is inaccessible except by at least one of the first TPM 110 and the second TPM 114, as previously mentioned. The system 160 may also include a display 164, including perhaps a cathode ray tube display, a liquid crystal display, a plasma display, or a light-emitting diode display, among others, coupled to at least one of the first TPM 110 and the second TPM 114.

The system 160 may further include a first computing platform partition 126 to couple to the first TPM 110 and a second computing platform partition 130 to couple to the second TPM 114. A secure communication channel 134, comprising perhaps one or more a wireless communication channels, may couple the first computing platform partition 126 to the second computing platform partition 130. Thus, the secure communication channel 134 may couple together one or more Institute of Electrical and Electronic Engineers (IEEE) 802.11 devices, general packet radio service devices, wideband code-division multiple-access devices, or combinations thereof, as may be included within the first and second computing platform partitions 126, 130. In some embodiments of the system 160, the secure communication channel 134 may comprise a bus, or shared access to a memory or to another device, as previously described.

Data 121 traversing the secure communication channel 134 may be encrypted using a session key 168 generated from one or more public portions 171, 172 of key-exchange keys (KEKs) passed between the second TPM 114 and the first TPM 110 over the physically protected communication channel 118.

Consider, for example, a case wherein the first computing platform partition 126 comprises a tape backup subsystem coupled to the first TPM 110. Consider further that the second computing platform partition 130 comprises a disk storage subsystem coupled to the second TPM 114. Finally, consider that the secure channel 134 comprises a bus used to transfer data between the disk storage subsystem and the tape backup subsystem, and that the protected communication channel 118 comprises a conductor imbedded within a single integrated circuit housing the first TPM 110 and the second TPM 114. The first TPM 110 (associated with the tape backup subsystem) may receive the public portion 172 of the KEK from the second TPM 114 (associated with the disk storage subsystem) over the conductor in order to generate the session key 168. Having thus authenticated the disk storage subsystem as another partition on the a same computing platform, the tape backup subsystem may then use the session key 168 to initiate a secure backup operation using encoded bi-directional data transfers between the disk storage subsystem and the tape backup subsystem, across the secure channel 134 (the bus).

Any of the components previously described can be implemented in a number of ways, including simulation via software. Thus, the apparatus 100; TPMs 110, 114; protected communication channel 118; data 121; integrated circuit package 122; encryption key distributions 123, 124; computing platform partitions 126, 130; secure communication channel 134; data 136; trust relationship 138; transactions 140; sessions 142; system 160; display 164; session key 168; and public portions of key-exchange keys 171, 172 may all be characterized as “modules” herein. Such modules may include hardware circuitry, single or multi-processor circuits, memory circuits, software program modules and objects, firmware, and combinations thereof, as desired by the architect of the apparatus 100 and system 160 and as appropriate for particular implementations of various embodiments. The modules may be included in a system operation simulation package such as a software electrical signal simulation package, a power usage and distribution simulation package, a capacitance-inductance simulation package, a power/heat dissipation simulation package, a signal transmission-reception simulation package, or any combination of software and hardware used to simulate the operation of various potential embodiments. These simulations may be used to characterize or test the embodiments, for example.

It should also be understood that the apparatus and systems of various embodiments can be used in applications other than exchanging encryption keys between TPM compartments within a multi-TPM module associated with a multi-partitioned platform. Thus, various embodiments are not to be so limited. The illustrations of apparatus 100 and system 160 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments may include a number of methods.

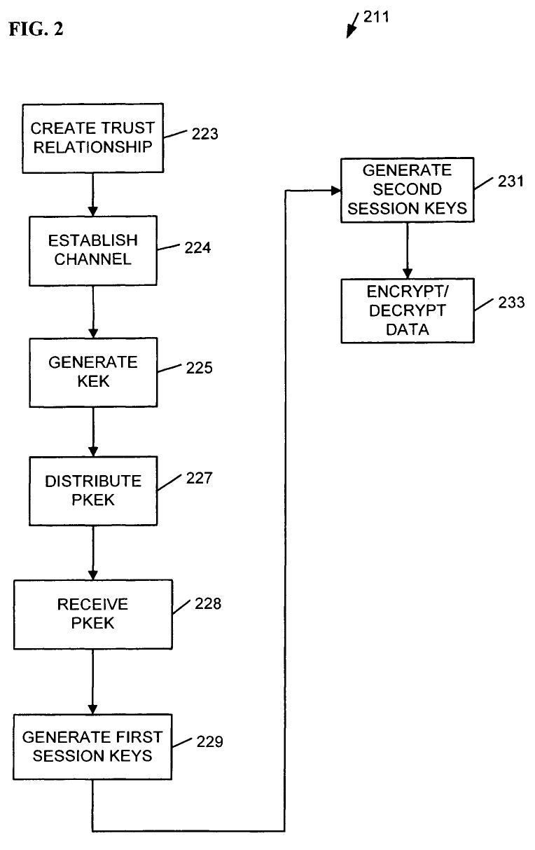

FIG. 2 is a flow diagram illustrating several methods 211 according to various embodiments of the invention. One such method 211 may begin at block 223 with creating a first trust relationship between a first computing partition coupled to a first TPM and a second computing partition coupled to a second TPM. The method 211 may continue with establishing a secure communication channel between the first computing partition and the second computing partition, at block 224. Establishing the secure communication channel may include polling an interface at the first computing partition, the second computing partition, or both, to determine whether the channel is active and ready to pass data. The first trust relationship may relate to communications across the secure communication channel.

The method 211 may include distribution of one or more cryptographic keys across a physically protected communication channel coupling a first TPM to a second TPM. Thus, the first trust relationship between the first computing partition and the second computing partition may be based upon a second trust relationship existing between the first TPM and the second TPM. The second trust relationship may in turn be based upon trust associated with the physically protected communication channel coupling the first TPM to the second TPM.

Thus, the method 211 may proceed at block 225 with issuing a first command to the first TPM to generate a first key-exchange key (KEK-1) and a second command to the second TPM to generate a second key-exchange key (KEK-2). The KEK-1 and the KEK-2 may comprise asymmetrical key-exchange keys, among other types of cryptographic keys. The KEK-1 and the KEK-2 may be created utilizing a key-exchange protocol comprising a transport layer security protocol, an internet key-exchange protocol, or an IEEE 802.11 protocol, among others. For more information on the various IEEE 802.11 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related versions.

The method 211 may include distributing the one or more cryptographic keys, including perhaps a public portion of the first key-exchange key (PKEK-1), a public portion of the second key-exchange key (PKEK-2), or both across a physically protected communication channel coupling the first TPM to the second TPM, at block 227. (E.g., the PKEK-1, the PKEK-2, or both may be embedded in one or more packets and transmitted across the physically protected communication channel.) Some variations of the method 211 may include limiting distribution of the PKEK-1 and the PKEK-2 to a single destination TPM from an originating TPM, or preventing re-distribution back to the originating TPM.

The method 211 may continue at block 228 with receiving the PKEK-2 at the first computing partition. The method 211 may also include generating a first set of session keys, perhaps at the first computing partition utilizing the PKEK-2, at block 229, wherein the first set of session keys is associated with a secure communication channel to couple the first computing partition to the second computing partition.

The method 211, may also include generating a second set of session keys utilizing the PKEK-1, to establish a bilateral trust relationship between the first computing partition and the second computing partition, at block 231. The first set of session keys and the second set of session keys may be generated utilizing random nonce and/or key-exchange context information associated with the distribution of at least one of the PKEK-1 and the PKEK-2. Key-exchange context information may comprise a hash of key-exchange messages associated with the distribution of at least one of the PKEK-1 and the PKEK-2. In some variations of the method 211, session key generation may occur within the first TPM, the second TPM, or both.

The method 211 may conclude at block 233 by receiving the PKEK-1 at the second computing partition to decrypt data encrypted using the first set of session keys and received from the first computing partition. The PKEK-1 may also be used by the second computing partition to encrypt data for transmission to the first computing partition. Thus, the method 211 may enable the flow of ciphertext (encrypted data) over the secure communication channel linking the first computing partition to the second computing partition. It should be noted that some variations of the method 211 may enable the flow of ciphertext directly across the physically protected communication channel linking the first TPM to the second TPM.

It should also be noted that the operations described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment. Other embodiments may be realized.

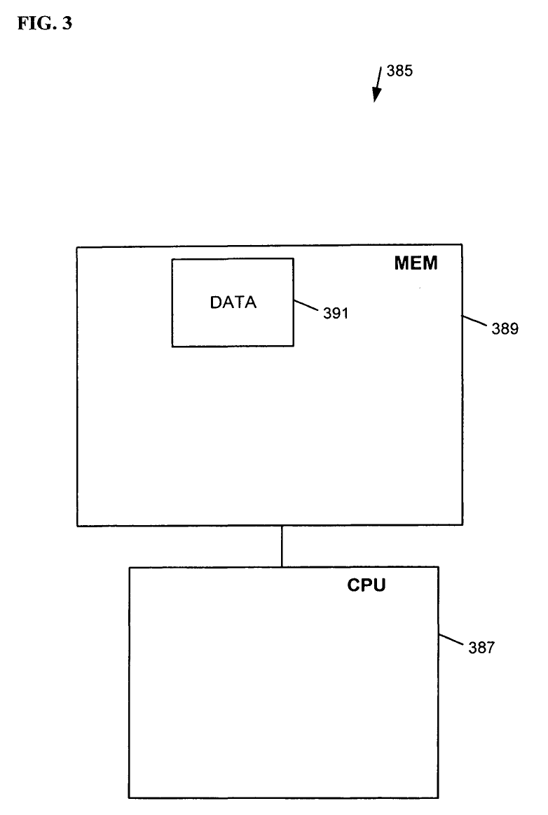

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) distributing a cryptographic key across a physically protected communication channel coupling a first trusted platform module (TPM) to a second TPM. The cryptographic key may comprise a PKEK-1, a PKEK-2, or both.

Other activities may include creating a KEK-1, a KEK-2, or both utilizing a key-exchange protocol comprising a transport layer security protocol, an internet key-exchange protocol, or an Institute of Electrical and Electronic Engineers 802.11 protocol. Further activities may include generating a session key from the PKEK-1 or the PKEK-2, utilizing random nonce and key-exchange context information associated with the distribution of the PKEK-1 or the PKEK-2.

Implementing the apparatus, systems, and methods disclosed herein may operate to establish a secure communication channel between partitions associated with a multi-partitioned computing platform. Confidentially generating and distributing encryption keys between the partitions may operate to implicitly authenticate the partitions to each other.

Although the inventive concept may include embodiments described in the exemplary context of an 802.xx implementation (e.g., 802.11a, 802.11g, 802.11 HT, 802.16, etc.), the claims are not so limited. Embodiments of the present invention may well be implemented as part of any wired or wireless system Examples may also include embodiments comprising multi-carrier wireless communication channels (e.g., orthogonal frequency-division multiplexing (OFDM), discrete multi-tone modulation (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a first trusted platform module (TPM); and
a second TPM to couple to the first TPM by a protected communication channel, wherein data traversing the protected communication channel is inaccessible except by at least one of the first TPM and the second TPM.

2. The apparatus of claim 1, wherein the protected communication channel is physically isolated from data probing operations.

3. The apparatus of claim 2, wherein the first TPM and the second TPM are included within a single integrated circuit package.

4. The apparatus of claim 3, wherein the protected communication channel is included within the single integrated circuit package.

5. The apparatus of claim 4, wherein the protected communication channel comprises a destructible-on-probing material.

6. The apparatus of claim 1, further including:
a first computing platform partition coupled to the first TPM and a second computing platform partition coupled to the second TPM.

7. The apparatus of claim 6, wherein the first computing platform partition and the second computing platform partition each comprises at least one of a microprocessor, a controller, a memory, a mass storage device, an input-output device, a power supply, a clock, and a transceiver.

8. The apparatus of claim 6, further including:
a secure communication channel to couple the first computing platform partition to the second computing platform partition.

9. The apparatus of claim 8, wherein the secure communication channel comprises at least one of a bus, a wireless link, shared access to a memory, and shared access to a data storage device.

10. The apparatus of claim 9, wherein the data storage device comprises at least one of a magnetic disk drive and an optical disk drive.

11. A system, including:
a first trusted platform module (TPM);
a second TPM to couple to the first TPM by a protected communication channel, wherein data traversing the protected communication channel is inaccessible except by at least one of the first TPM and the second TPM; and
a liquid crystal display coupled to at least one of the first TPM and the second TPM.

12. The system of claim 11, further including:
a first computing platform partition to couple to the first TPM and a second computing platform partition to couple to the second TPM.

13. The system of claim 12, further including:
a secure communication channel to couple the first computing platform partition to the second computing platform partition, wherein data traversing the secure communication channel is encrypted using a session key generated from a public portion of a key-exchange key passed between the second TPM and the first TPM over the physically protected communication channel.

14. The system of claim 13, wherein the secure communication channel comprises at least one wireless communication channel.

15. The system of claim 14, wherein the at least one wireless communication channel is coupled to at least one of an Institute of Electrical and Electronic Engineers 802.11 device, a general packet radio service device, and a wideband code-division multiple-access device.

16. A method, including:
distributing a cryptographic key across a physically protected communication channel coupling a first trusted platform module (TPM) to a second TPM.

17. The method of claim 16, wherein the cryptographic key comprises at least one of a public portion of a first key-exchange key (PKEK-1 of KEK-1) and a public portion of a second key-exchange key (PKEK-2 of KEK-2).

18. The method of claim 17, wherein at least one of the KEK-1 and the KEK-2 comprises an asymmetrical key-exchange key.

19. The method of claim 17 further including:
limiting distribution of the PKEK-1 and the PKEK-2 to a single destination TPM from an originating TPM; and
preventing re-distribution back to the originating TPM.

20. The method of claim 17 further including:
issuing a first command to the first TPM to generate the KEK-1 and a second command to the second TPM to generate the KEK-2.

21. The method of claim 17, further including:
creating a trust relationship between a first computing partition coupled to the first TPM and a second computing partition coupled to the second TPM.

22. The method of claim 21, further including:
establishing a secure communication channel between the first computing partition and the second computing partition.

23. The method of claim 22, further including:
receiving the PKEK-2 at the first computing partition;
generating a first set of session keys at the first computing partition utilizing the PKEK-2, wherein the first set of session keys is associated with the secure communication channel; and
receiving the PKEK-1 at the second computing partition to decrypt data encrypted using the first set of session keys and received from the first computing partition.

24. The method of claim 23, further including:
generating a second set of session keys utilizing the PKEK-1, to establish a bilateral trust relationship between the first computing partition and the second computing partition.

25. The method of claim 24, wherein at least one of the first set of session keys and the second set of session keys is generated utilizing at least one of a random nonce and key-exchange context information associated with the distribution of at least one of the PKEK-1 and the PKEK-2.

26. The method of claim 25, wherein the key-exchange context information comprises a hash of key-exchange messages associated with the distribution of at least one of the PKEK-1 and the PKEK-2.

27. An article including a machine-accessible medium having associated information, wherein the information, when accessed, results in a machine performing:
distributing a cryptographic key across a physically protected communication channel coupling a first trusted platform module (TPM) to a second TPM.

28. The article of claim 27, wherein the cryptographic key comprises at least one of a public portion of a first key-exchange key (PKEK-1 of KEK-1) and a public portion of a second key-exchange key (PKEK-2 of KEK-2).

29. The article of claim 28, wherein the information, when accessed, results in a machine performing:
creating at least one of the KEK-1 and the KEK-2 utilizing a key-exchange protocol comprising at least one of a transport layer security protocol, an internet key-exchange protocol, and an Institute of Electrical and Electronic Engineers 802.11 protocol.

30. The article of claim 28, wherein the information, when accessed, results in a machine performing:
generating a session key from at least one of the PKEK-1 and the PKEK-2, utilizing a random nonce and key-exchange context information associated with the distribution of at least one of the PKEK-1 and the PKEK-2.
